(19) United States
(12) Patent Application Publication
(10) Pub. No.: US 2026/0335766 A1
(43) Pub. Date: Oct. 29, 2026

(54) METHOD AND APPARATUS FOR VIRTUAL OBJECT INTERACTION, DEVICE, AND COMPUTER-READABLE STORAGE MEDIUM

(71) Applicant: Century Games Pte. Ltd., Singapore (SG)

(72) Inventors: Congnan Huang, Fuzhou City (CN); Dandan Chen, Fuzhou City (CN); Liangqing Sun, Fuzhou City (CN); Hao Sun, Fuzhou City (CN)

(21) Appl. No.: 19/448,607

(22) Filed: Jan. 14, 2026

(30) Foreign Application Priority Data
Apr. 27, 2025 (CN) 202510535284.2

(51) Int. Cl. A63F 13/56; A63F 13/52; A63F 13/69

(52) U.S. Cl. CPC A63F 13/56; A63F 13/52; A63F 13/69

(57) ABSTRACT

The disclosure pertains to games. Disclosed are a method and apparatus for virtual object interaction, and a device and a computer-readable storage medium thereof. The method includes: displaying a first virtual object and a virtual resource within a virtual scene; displaying, in a case where a first condition is fulfilled, movement of virtual resource moves from a position where the virtual resource is located to a resource collection prop corresponding to the first virtual object; and displaying, in a case where a second condition is fulfilled, upgrade of resource-consuming equipment with virtual resources that have been collected by the resource collection prop corresponding to the first virtual object, to adjust or maintain an environment parameter for the first virtual object to survive within a target area affected by the resource-consuming equipment. This enhances game playability with diversified interactions of the virtual objects and more flexible interaction modes.

### CROSS-REFERENCE TO RELATED APPLICATIONS

This application claims the benefit of Chinese patent application No. 202510535284.2 filed on Apr. 27, 2025, now Chinese patent No. CN120393418 B granted on Oct. 10, 2025, which is incorporated herein by reference.

### TECHNICAL FIELD

Embodiments of the present disclosure relate to the field of human-computer interaction, and in particular, relate to a method and apparatus for virtual object interaction, and a device and a computer-readable storage medium thereof.

### BACKGROUND

With the continuous development of computer technologies, the types of video games are becoming more and more abundant, for example, a shooting game, a role-playing game, or a business strategy game. In a video game, the activities of a virtual object within a virtual scene can be controlled, for example, the movement of the virtual object within the virtual scene is controlled.

In the related art, virtual resources are arranged within the virtual scene, and a game player may control the virtual object to move in the virtual scene to acquire the virtual resources within the virtual scene.

However, in the above method, the virtual object may acquire only the virtual resources resulting in monotonous interaction and low engagement with the virtual object.

### SUMMARY

Embodiments of the present disclosure provide a method and apparatus for virtual object interaction, and a device and a readable storage medium thereof, which are used to solve problems in the related art. The technical solutions are as follows.

In one aspect, a method for virtual object interaction is provided. The method includes: displaying a first virtual object and a virtual resource within a virtual scene; displaying, in a case where a first condition is fulfilled, movement of the virtual resource from a position where the virtual resource is located to a resource collection prop corresponding to the first virtual object; and displaying, in a case where a second condition is fulfilled, upgrade of resource-consuming equipment with virtual resources that have been collected by the resource collection prop corresponding to the first virtual object, to adjust or maintain an environmental parameter for the first virtual object to survive within a target area affected by the resource-consuming equipment.

In another aspect, an apparatus for virtual object interaction is provided. The apparatus includes: a displaying module, configured to display a first virtual object and a virtual resource within a virtual scene; wherein the displaying module is further configured to display, in a case where a first condition is fulfilled, movement of the virtual resource from a position where the virtual resource is located to a resource collection prop corresponding to the first virtual object; and the displaying module is further configured to display, in a case where a second condition is fulfilled, upgrade of resource-consuming equipment with virtual resources that have been collected by the resource collection prop corresponding to the first virtual object, to adjust or maintain an environmental parameter for the first virtual object to survive within a target area affected by the resource-consuming equipment.

In some embodiments, the displaying module is configured to: display, in a case where the second condition is fulfilled, the upgrade of the resource-consuming equipment with the virtual resources that have been collected by the resource collection prop corresponding to the first virtual object, to adjust the environmental parameter for the first virtual object to survive within the target area affected by the resource-consuming equipment, wherein the environmental parameter for the first virtual object to survive within the target area affected by the resource-consuming equipment upon the upgrade of the resource-consuming equipment is more favorable than an environmental parameter for the first virtual object to survive within the target area affected by the resource-consuming equipment prior to the upgrade of the resource-consuming equipment; or display, in a case where the second condition is fulfilled and the virtual scene changes from a first scene environment to a second scene environment, the upgrade of the resource-consuming equipment with the virtual resources that have been collected by the resource collection prop corresponding to the first virtual object, to maintain the environmental parameter for the first virtual object to survive within the target area affected by the resource-consuming equipment, wherein the environmental parameter for the first virtual object to survive within the target area affected by the resource-consuming equipment upon the upgrade of the resource-consuming equipment is the same as the environmental parameter for the first virtual object to survive within the target area affected by the resource-consuming equipment prior to the upgrade of the resource-consuming equipment, wherein the second scene environment is harsher than the first scene environment.

In some embodiments, a level of the upgraded resource-consuming equipment is determined based on a number of the virtual resources that have been collected by the resource collection prop corresponding to the first virtual object, and upon the upgrade of the resource-consuming equipment, the environmental parameter for the first virtual object to survive within the target area affected by the resource-consuming equipment is determined based on the level of the upgraded resource-consuming equipment.

In some embodiments, the environmental parameter for the first virtual object to survive within the target area affected by the resource-consuming equipment includes a scene temperature of the virtual scene; the displaying module is further configured to display the scene temperature of the virtual scene; and the apparatus further includes: a determining module, configured to determine a target temperature, wherein the target temperature is the scene temperature of the virtual scene upon the upgrade of the resource-consuming equipment, and the target temperature is determined based on the level of the upgraded resource-consuming equipment; wherein the displaying module is further configured to update the displayed scene temperature of the virtual scene to the target temperature.

In some embodiments, the display module is further configured to display a first area in a target form, wherein the first area is determined based on a position where the first virtual object is located and the level of the upgraded resource-consuming equipment, and the target form is configured to indicate that the first virtual object is not attacked by a second virtual object in a case where the first virtual object is within the first area, wherein the second virtual object is a hostile virtual object to the first virtual object.

In some embodiments, the second condition includes one of:
the number of the virtual resources that have been collected by the resource collection prop corresponding to the first virtual object being not less than a number threshold, wherein the number threshold indicates a number of virtual resources required by the resource-consuming equipment to upgrade from a current level to a next level;
the number of the virtual resources that have been collected by the resource collection prop corresponding to the first virtual object being not less than the number threshold, and the first virtual object being within a reference area, wherein the reference area is determined based on a position where the resource-consuming equipment is located;
the number of the virtual resources that have been collected by the resource collection prop corresponding to the first virtual object being not less than the number threshold, and a scene environment of the virtual scene changing; or
the number of the virtual resources that have been collected by the resource collection prop corresponding to the first virtual object being not less than the number threshold, and a second virtual object attacks the first virtual object, wherein the second virtual object is a hostile virtual object to the first virtual object.

In some embodiments, the displaying module is further configured to display, in a case where a number of the virtual resources that have been collected by the resource collection prop corresponding to the first virtual object is not less than a number threshold, a prompt control, wherein the prompt control indicates that the resource-consuming equipment is upgradable, and the number threshold indicates a number of virtual resources required by the resource-consuming equipment to upgrade from a current level to a next level.

In some embodiments, the displaying module is further configured to display, in response to a trigger operation for the prompt control, an indication element, wherein the indication element indicates a direction of the resource-consuming equipment relative to the first virtual object.

In some embodiments, the displaying module is further configured to display the upgraded resource-consuming equipment, wherein an appearance of the upgraded resource-consuming equipment is different from an appearance of the resource-consuming equipment prior to the upgrade.

In some embodiments, the first virtual object performs a scene exploration task in the virtual scene, the virtual scene is covered by a granular covering, the first virtual object holds a first virtual prop, and the first virtual prop is configured to eliminate the granular covering in an application range of the virtual prop; and the apparatus further includes: an adjusting module, configured to adjust the application range of the first virtual prop, wherein the adjusted application range of the first virtual prop is greater than the application range of the first virtual prop prior to the adjustment.

In some embodiments, the apparatus further includes: a transferring module, configured to transfer a second virtual prop to a control object of the first virtual object, wherein the second virtual prop is configured to determine a temperature of a second area as a reference temperature in a case where the first virtual object is equipped with the second virtual prop, wherein the second area is determined based on a position where the first virtual object is located, and the reference temperature is determined based on the second virtual prop.

In some embodiments, the apparatus further includes: a determining module, configured to determine a third area based on the position of the resource-consuming equipment and an adjusted level of the resource-consuming equipment, wherein the third area is greater than a safety area provided by the upgraded resource-consuming equipment; wherein the displaying module is further configured to display that a virtual resource within the third area moves from a position of the virtual resource to the resource collection prop corresponding to the first virtual object.

In yet another aspect, a computer device is provided. The computer device includes a processor and a memory storing at least one program code. The at least one program code, when loaded and executed by the processor, causes the computer device to perform any one of the methods for virtual object interaction described above.

In still another aspect, a computer-readable storage medium is further provided. The computer-readable storage medium stores at least one program code. The at least one program code, when loaded and executed by a processor, causes a computer to perform any one of the methods for virtual object interaction described above.

In yet still another aspect, a computer program or a computer program product is further provided. The computer program or the computer program product stores at least one computer instruction. The at least one computer instruction, when loaded and executed by a processor, causes a computer to perform any one of the methods for virtual object interaction described above.

The technical solutions according to the embodiments of the present disclosure at least achieve following beneficial effects:

According to the technical solutions of the embodiments of the present disclosure, the game player controls the first virtual object to move in the virtual scene, and in the case where the first condition is fulfilled, the movement of the virtual resource from the position where the virtual resource is located to the resource collection prop corresponding to the first virtual object is displayed, to visualize the process of the first virtual object collecting the virtual resource. In the case where the second condition is fulfilled, the resource-consuming equipment is upgraded with the virtual resources collected by the first virtual object, to adjust or maintain the environmental parameter for the first virtual object to survive within the target area affected by the resource-consuming equipment. In this way, the game player can not only collect virtual resources within the virtual scene, but also consume the virtual resources to upgrade the resource-consuming equipment, such that the interaction modes of the virtual objects are diversified, the interaction modes are more flexible, and the interaction rate of the virtual objects is increased, thereby enriching the gameplay of the game. As a result, the playability of the game is higher, the interactive fun of the game is increased, and thus the player's sense of participation and achievement in the game is enhanced, thereby improving the interactivity and user retention rate of the game.

### BRIEF DESCRIPTION OF DRAWINGS

For clearer descriptions of the technical solutions in embodiments of the present disclosure, the following briefly describes the accompanying drawings required for describing the embodiments. Apparently, the accompanying drawings in the following description show merely some embodiments of the present disclosure, and those of ordinary skill in the art may still derive other accompanying drawings from these accompanying drawings without creative efforts.

FIG. 1 is a schematic diagram of a computer system according to some embodiments of the present disclosure;

FIG. 2 is a flowchart of a method for virtual object interaction according to some embodiments of the present disclosure;

FIG. 3 is a schematic diagram of a game interface according to some embodiments of the present disclosure;

FIG. 4 is a schematic diagram of a countdown control according to some embodiments of the present disclosure;

FIG. 5 is a schematic diagram of another countdown control according to some embodiments of the present disclosure;

FIG. 6 is a schematic diagram of a prompt control according to some embodiments of the present disclosure;

FIG. 7 is a schematic diagram of an indication element according to some embodiments of the present disclosure;

FIG. 8 is a schematic diagram of upgrading resource-consuming equipment from virtual resources that have been collected by a resource collection prop corresponding to a first virtual object according to some embodiments of the present disclosure;

FIG. 9 is a schematic structural diagram of an apparatus for virtual object interaction according to some embodiments of the present disclosure;

FIG. 10 is a schematic structural diagram of a terminal device according to some embodiments of the present disclosure; and

FIG. 11 is a schematic structural diagram of a server according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

It should be noted that the terms “first,” “second,” or the like in the present disclosure are configured to distinguish similar objects, and do not have to be used to describe a specific order or sequence. It should be understood that the terms so used are interchangeable under appropriate circumstances such that the embodiments of the present disclosure described herein are implementable in other sequences than those illustrated or described herein. The embodiments described in the following exemplary embodiments do not represent all embodiments consistent with the present disclosure. Rather, they are merely examples of apparatus and methods consistent with some aspects of the present disclosure, as detailed in the appended claims.

First, abbreviations and key terms involved in the embodiments of the present disclosure are defined.

Virtual scene: A virtual scene is a scene provided (or displayed) in a case where an application program is executed on a terminal device, and the virtual scene is a created scene for a virtual object to perform an activity. The virtual scene may be a two-dimensional virtual scene, a 2.5-dimensional virtual scene, a three-dimensional virtual scene, or the like. The virtual scene may be a simulation scene of the real world, or may be a semi-simulation scene of the real world, or may be an entirely fictional scene. Exemplarily, the virtual scene involved in the embodiments of the present disclosure is a three-dimensional virtual scene.

Virtual object: A virtual object is a movable object in a virtual scene, and the movable object may be a virtual character, a virtual animal, a cartoon character, or the like. A user may control the virtual object by using a peripheral component or by clicking a touch display screen. Each virtual object has its own shape and volume in the virtual scene, and occupies a part of space in the virtual scene. Exemplarily, when the virtual scene is a three-dimensional virtual scene, the virtual object is a three-dimensional model created based on the animation skeleton technology.

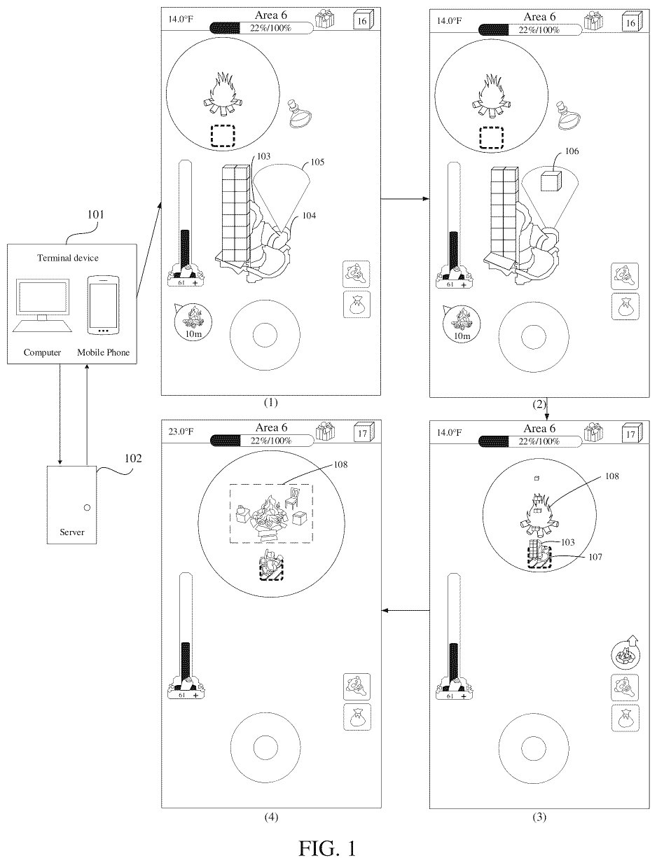

FIG. 1 is a schematic diagram of a computer system according to some embodiments of the present disclosure. As illustrated in FIG. 1, the computer system includes a terminal device 101 and a server 102. A game client is installed and runnable in the terminal device 101. The method for virtual object interaction according to the embodiments of the present disclosure may be performed by the terminal device 101, or may be performed by both the terminal device 101 and the server 102, which is not limited in the embodiments of the present disclosure.

The server 102 is configured to provide a backend service for the game client installed on the terminal device 101. In some embodiments, the server 102 is responsible for primary computing tasks, and the terminal device 101 is responsible for secondary computing tasks. Alternatively, the server 102 is responsible for secondary computing tasks, and the terminal device 101 is responsible for primary computing tasks. Alternatively, the terminal device 101 and the server 102 perform collaborative computing by using a distributed computing architecture.

The game client may be a third-person shooting (TPS) game, a first-person shooting (FPS) game, a multiplayer online battle arena (MOBA) game, a multiplayer shooting survival game, a massive multiplayer online role-playing game (MMO), an action role-playing game (ARPG), a business strategy game, a virtual reality (VR) client, an augmented reality (AR) client, a three-dimensional map program, a map simulation program, a social client, an interactive entertainment client, or the like.

The type of the game client is not limited in the embodiments of the present disclosure. For example, the game client may be an application program that needs to be downloaded and installed, a mini program that does not need to be downloaded, a web application program, or the like.

In some embodiments, the terminal device 101 is any electronic device product capable of performing human-computer interaction with a user by one or more methods such as a keyboard, a touch pad, a remote control, or a voice interaction or handwriting device. For example, the terminal device 101 may be a smart phone, a tablet computer, a notebook computer, a desktop computer, a smart speaker, a smart watch, a personal computer (PC), a mobile phone, a personal digital assistant (PDA), a wearable device, a pocket PC (PPC), a smart in-vehicle infotainment, a smart television, or the like.

The terminal device 101 may generally refer to one of a plurality of terminal devices, and the embodiments are illustrated only by using the terminal device 101. Those skilled in the art will appreciate that the number of the terminal devices 101 can vary. For example, there may be only one terminal device 101, or there may be dozens or hundreds of the terminal devices 101, or even more. The number and the device type of the terminal devices 101 are not limited in the embodiments of the present disclosure.

The server 102 is a single server, a server cluster composed of a plurality of servers, or any one of a cloud computing platform or a virtualization center, which is not limited in the embodiments of the present disclosure. The server 102 is in direct or indirect communication connection with the terminal device 101 via wired communication or wireless communication. The server 102 features a data reception function, a data processing function, and a data transmission function. In addition, the server 102 may further feature another function, which is not limited in the embodiments of the present disclosure.

In the method for virtual object interaction according to the present disclosure, the terminal device 101 displays a game interface illustrated in (1), a first virtual object 103 located in a virtual scene is displayed in the game interface illustrated in (1), the first virtual object 103 holds a first virtual prop 104, and the first virtual prop 104 is configured to eliminate a granular covering in an application range 105 of the first virtual prop 104. In a case where the first virtual prop 104 eliminates the granular covering in the application range 105 of the first virtual prop 104, and a virtual resource 106 exists in the application range 105 of the first virtual prop 104, a game interface illustrated in (2) is displayed, and the virtual resource 106 located in the virtual scene is displayed in the game interface illustrated in (2). In a case where the distance between the first virtual object 103 and the virtual resource 106 is less than a distance threshold, it is displayed that the virtual resource 106 moves from the position where the virtual resource 106 is located to a resource collection prop corresponding to the first virtual object 103.

In a case where the number of virtual resources that have been collected by the resource collection prop corresponding to the first virtual object 103 is not less than a number threshold, and the first virtual object 103 is located in a reference area 107, a game interface illustrated in (3) is displayed, and it is displayed, in the game interface illustrated in (3), that the virtual resources that have been collected by the resource collection prop corresponding to the first virtual object 103 move to resource-consuming equipment 108. Upon movement of the virtual resources that have been collected by the resource collection prop corresponding to the first virtual object 103 to the resource-consuming equipment 108, a game interface illustrated in (4) is displayed. In the game interface illustrated in (4), the appearance of the resource-consuming equipment 108 changes, the safety area provided by the resource-consuming equipment 108 becomes larger, and the scene temperature of the virtual scene becomes higher.

The number threshold indicates the number of virtual resources required by the resource-consuming equipment 108 to upgrade from the current level to the next level, and the reference area 107 is any area in the safety area provided by the resource-consuming equipment 108.

Those skilled in the art should understand that the terminal device 101 and the server 102 are merely examples for description, and other conventional or future terminal devices or servers applicable to the present disclosure shall also fall within the protection scope of the present disclosure and are hereby incorporated by reference.

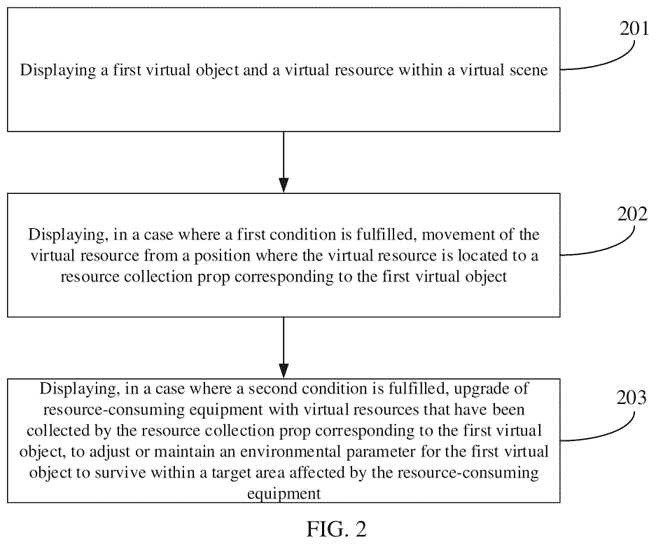

The embodiments of the present disclosure provide a method for virtual object interaction, and the method may be applicable to the computer system illustrated in FIG. 1. A flowchart of a method for virtual object interaction according to some embodiments of the present disclosure illustrated in FIG. 2 is used as an example, and the method may be performed by the terminal device 101 in FIG. 1. As illustrated in FIG. 2, the method includes the following steps 201 to 203.

In step 201, a first virtual object and a virtual resource located in a virtual scene are displayed.

In some exemplary embodiments of the present disclosure, a game client capable of providing a virtual scene is installed and executed in the terminal device, and the game client is a client of any game, which is not limited in the embodiments of the present disclosure. Exemplarily, the game client is a business strategy client. A plurality of virtual objects are displayed in the virtual scene. Different virtual objects are controlled by different terminal devices or servers. In addition to displaying virtual objects, virtual elements are also displayed in the virtual scene. The virtual elements may be any element, and the virtual elements are not limited in the embodiments of the present disclosure. In some embodiments, the virtual elements include mountains, plains, rivers, lakes, oceans, deserts, swamps, quicksand, skies, plants, snowfields, buildings, coal briquettes, snowmen, and the like. The description of the virtual scene in the present disclosure is merely exemplary and does not limit the virtual scene.

In some embodiments, the display interface of the terminal device displays the related information of the game client, and the related information of the game client is the name of the game client, the icon of the game client, or other information representing the game client, which is not limited in the embodiments of the present disclosure. In a case where a game player wants to execute the game client, the game player triggers the related information of the game client, and the terminal device executes the game client in response to a trigger operation for the related information of the game client, and displays a game interface. A first virtual object located in the virtual scene is displayed in the game interface, the virtual scene is covered by a granular covering, the first virtual object performs a scene exploration task in the virtual scene, the first virtual object holds a first virtual prop, and the first virtual prop is configured to eliminate the granular covering in the application range of the first virtual prop.

The scene exploration task is a task with vision expansion and/or resource collection as a core in the game. The game player may explore the virtual scene by controlling the first virtual object to move and interact in the virtual scene, thereby advancing the game process, acquiring virtual resources, or unlocking the virtual scene.

In some embodiments, the virtual scene is covered by a granular covering. The scene exploration task is a task of eliminating the granular covering in the virtual scene. Alternatively, there is a virtual resource in the virtual scene, and the scene exploration task is a task of collecting the virtual resource in the virtual scene. Alternatively, there is a virtual resource in the virtual scene, and the virtual resource is covered by a granular covering. The scene exploration task is a task of eliminating the granular covering in the virtual scene and collecting the virtual resource in the virtual scene.

The first virtual object is a virtual object controlled by a game player using the terminal device, or the first virtual object is a virtual object controlled by a client, which is not limited in the embodiments of the present disclosure. The trigger operation for the related information of the game client includes at least one of a touch operation, a handle trigger operation, a voice instruction trigger operation, or a gesture trigger operation for the related information of the game client. The trigger operation for other content in the following content is similar to the trigger operation for the related information of the game client. In a case where the trigger operation for other content is involved in the following content, details are not described in the embodiments of the present disclosure.

In some embodiments, the granular covering is snow, water, sand, or the like, which is not limited in the embodiments of the present disclosure. The application range of the first virtual prop is determined based on the position where the first virtual object is located.

In some embodiments, the application range of the first virtual prop is determined based on the position where the first virtual object is located, a first length, and a first angle. The first length and the first angle are determined based on a target number, and the target number is the number of virtual objects whose states are changed by the first virtual object. The more virtual objects whose states are changed by the first virtual object, the larger the target number, the larger the first length and the first angle, and the larger the application range of the first virtual prop. Exemplarily, in a case where there are three virtual objects whose states are changed by the first virtual object, the target number is 3, the first length determined based on the target number is 1 meter (m), and the first angle is 30 degrees.

In some embodiments, the application range of the first virtual prop is a sector with the position where the first virtual object is located as a vertex, the first length as a radius, and the first angle as a circular arc angle. Exemplarily, the application range of the first virtual prop is a sector with the position where the first virtual object is located as the vertex, the radius of 1 m, and the circular arc angle of 30 degrees.

In the embodiments, the application range of the first virtual prop held by the first virtual object is a sector-shaped area with the position where the first virtual object is located as the vertex, the first length as the radius, and the first angle as the circular arc angle, which greatly expands the application range of the first virtual prop, such that the first virtual object is capable of covering a large range without a large movement, thereby increasing the elimination efficiency of the first virtual object.

In response to the first virtual prop eliminating the granular covering in the application range of the first virtual prop and the virtual resource in the application range of the first virtual prop, the virtual resource located in the virtual scene is displayed. The virtual resource may be coal briquettes, ore, or other resources, which is not limited in the embodiments of the present disclosure.

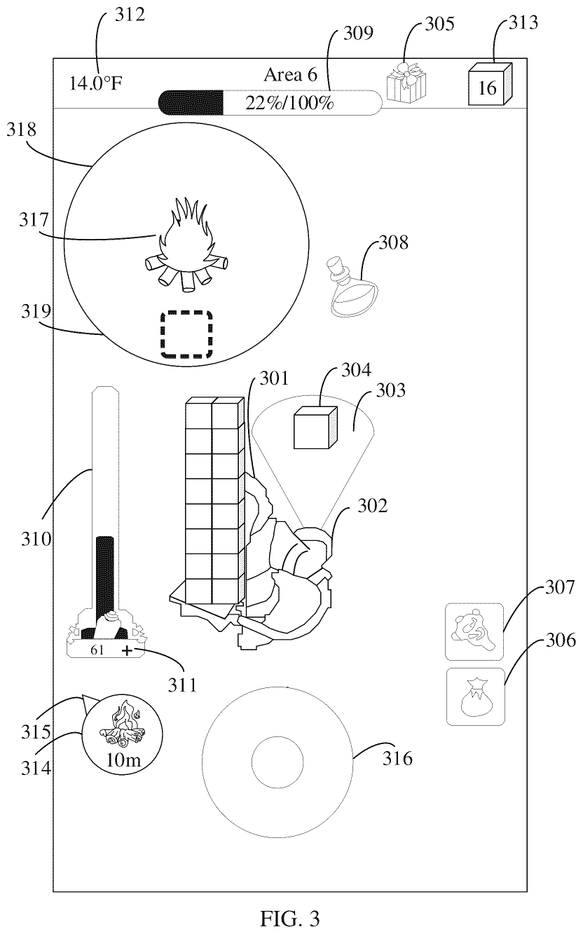

FIG. 3 is a schematic diagram of a game interface according to some embodiments of the present disclosure. A first virtual object 301 located in a virtual scene is displayed, and the first virtual object 301 holds a first virtual prop 302. The application range of the first virtual prop 302 is 303, the first virtual prop 302 eliminates a granular covering in the application range 303 of the first virtual prop 302, and a virtual resource 304 exists in the application range 303 of the first virtual prop 302. Therefore, the virtual resource 304 is further displayed.

In some embodiments, the task name of the scene exploration task is further displayed in the game interface. As illustrated in FIG. 3, “Area 6” represents the task name of the scene exploration task.

In some embodiments, a first control is further displayed in the game interface, the first control is configured to display the resource information of a first virtual resource, and the first virtual resource is a virtual resource obtainable upon completion of the scene exploration task. As illustrated in FIGS. 3, 305 represents the first control. In response to a trigger operation for the first control, the resource information of the first virtual resource is displayed. The resource information of the first virtual resource is the resource name of the first virtual resource, the resource icon of the first virtual resource, or other information representing the first virtual resource uniquely, which is not limited in the embodiments of the present disclosure.

In the embodiments, by displaying the first control, the game player views the resource information of the first virtual resource obtainable upon completion of the scene exploration task by triggering the first control. In this way, the exploration desire and the challenge enthusiasm of the game player are effectively stimulated, to drive the game player to complete the scene exploration task with the definite reward expectation, thereby improving the game fun.

In some embodiments, a second control is further displayed in the game interface, the second control is configured to display the resource information of a second virtual resource, and the second virtual resource is a virtual resource perceived by the first virtual object in the virtual scene. As illustrated in FIGS. 3, 306 represents the second control. In response to a trigger operation for the second control, the resource information of the second virtual resource is displayed. The resource information of the second virtual resource is the resource name of the second virtual resource, the resource icon of the second virtual resource, or other information representing the second virtual resource uniquely, which is not limited in the embodiments of the present disclosure.

The second virtual resource is a virtual resource that the first virtual object has encountered in the virtual scene, a virtual resource that the first virtual object has picked up in the virtual scene, or a virtual resource obtained by the first virtual object upon defeating another virtual object in the virtual scene, or a virtual resource obtained by the first virtual object upon opening a virtual treasure chest in the virtual scene. The source of the second virtual resource is not limited in the embodiments of the present disclosure.

In the embodiments, by displaying the second control, the game player views the resource information of the second virtual resource perceived by the first virtual object by triggering the second control. In this way, the exploration desire and the challenge enthusiasm of the game player are effectively stimulated, to drive the game player to complete the scene exploration task with the definite reward expectation, thereby improving the game fun.

In some embodiments, in a case where the first virtual object completes the scene exploration task, the second virtual resource is transferred to the account of a control object of the first virtual object. That is, the control object of the first virtual object acquires the virtual resource perceived by the first virtual object in the virtual scene only in a case where the first virtual object completes the scene exploration task. In this way, the game player is prompted to control the first virtual object to complete the scene exploration task, which makes the game more playable and improves the game fun, thereby increasing the user retention rate of the game.

In some embodiments, the process of transferring the second virtual resource to the account of the control object of the first virtual object includes: transmitting the object information of the control object of the first virtual object and the resource information of the second virtual resource to a server. The server transfers the second virtual resource to the account of the control object of the first virtual object.

In some embodiments, in a case where the first virtual object completes the scene exploration task, the first virtual resource further needs to be transferred to the account of the control object of the first virtual object. The process of transferring the first virtual resource to the account of the control object of the first virtual object is similar to the process of transferring the second virtual resource to the account of the control object of the first virtual object, and details are not described in the embodiments of the present disclosure.

In some embodiments, a third control is further displayed in the game interface, and the third control is configured to display the prop information of the first virtual prop and an upgrade control corresponding to the first virtual prop. As illustrated in FIGS. 3, 307 represents the third control. In response to a trigger operation for the upgrade control corresponding to the first virtual prop, the first virtual prop is upgraded. The application range of the upgraded first virtual prop is greater than the application range of the first virtual prop prior to the upgrade. The prop information of the first virtual prop is the prop name of the first virtual prop, the prop icon of the first virtual prop, or other information representing the first virtual prop uniquely, which is not limited in the embodiments of the present disclosure.

In the embodiments, the game player expands the application range of the first virtual prop by upgrading the first virtual prop, such that the gameplay is more diversified, thereby increasing the interaction rate of the game and increasing the user retention rate of the game.

In some embodiments, the third control is further configured to display the wearing information of the first virtual object and an upgrade control corresponding to the wearing information. In response to the upgrade control corresponding to the wearing information, the wearing information of the first virtual object is upgraded. The cold tolerance of the upgraded wearing information of the first virtual object is greater than the cold tolerance of the wearing information of the first virtual object prior to the upgrade. The wearing information of the first virtual object includes, but is not limited to, information about clothes, information about shoes, and the like of the first virtual object. The information about the clothes includes, but is not limited to, the name of the clothes and the picture of the clothes. The information about the shoes includes, but is not limited to, the name of the shoes and the picture of the shoes.

In some embodiments, a third virtual resource located in the virtual scene is further displayed in the game interface, and the third virtual resource is configured to generate a gain for the first virtual prop. As illustrated in FIGS. 3, 308 represents the third virtual resource. In a case where the distance between the first virtual object and the third virtual resource is less than a distance threshold, it is displayed that the first virtual object picks up the third virtual resource. In a case where the first virtual object picks up the third virtual resource, the application range of the first virtual prop held by the first virtual object is greater than the application range of the first virtual prop held by the first virtual object before the first virtual object picks up the third virtual resource.

The distance threshold is set based on experience, or is flexibly adjusted based on an implementation environment, which is not limited in the embodiments of the present disclosure. Exemplarily, the distance threshold is 1 m.

In the embodiments, the game player expands the application range of the first virtual prop held by the first virtual object by controlling the first virtual object to pick up the third virtual resource, which increases the efficiency of the game player in completing the scene exploration task and makes the game more playable, thereby improving the fun of game interaction and increasing the user retention rate of the game.

In some embodiments, in a case where the distance between the first virtual object and the third virtual resource is less than the distance threshold, when the first virtual object picking up the third virtual resource is displayed, a countdown control is further displayed, and the countdown control is configured to indicate a remaining time during which the first virtual prop held by the first virtual object has a gain.

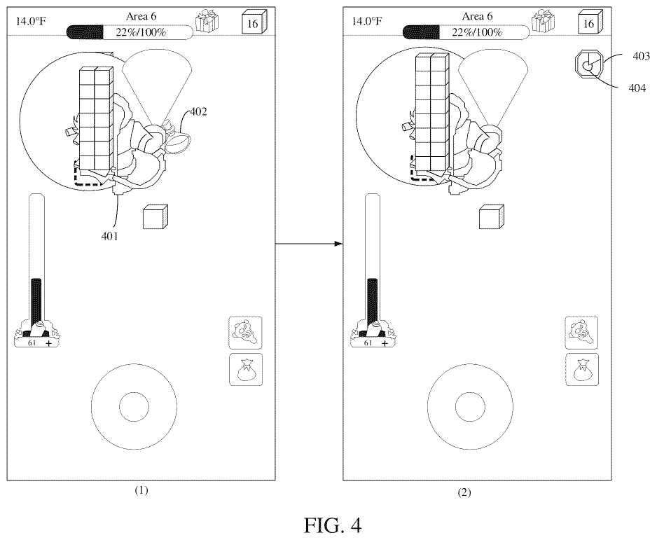

FIG. 4 is a schematic diagram of a countdown control according to some embodiments of the present disclosure. In a case where the distance between a first virtual object 401 and a third virtual resource 402 displayed in (1) of FIG. 4 is less than a distance threshold, it is displayed that the first virtual object 401 picks up the third virtual resource 402, and then (2) of FIG. 4 is displayed, wherein a countdown control 403 is displayed, and 404 in the countdown control 403 is a remaining time during which the first virtual prop held by the first virtual object has a gain.

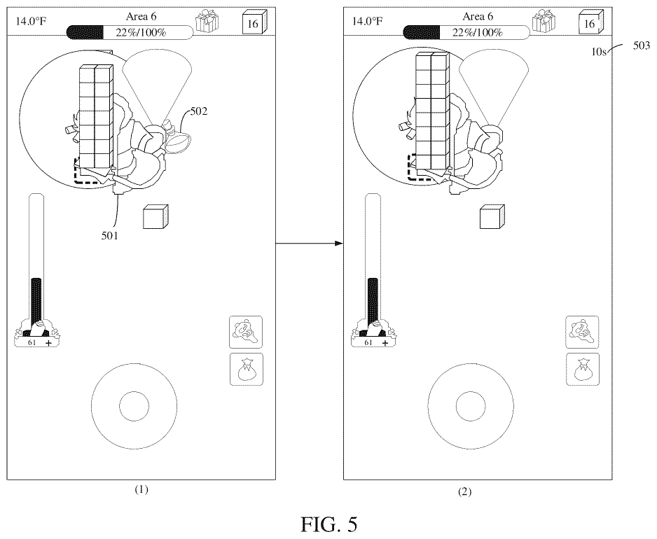

FIG. 5 is a schematic diagram of another countdown control according to some embodiments of the present disclosure. In a case where the distance between a first virtual object 501 and a third virtual resource 502 displayed in (1) of FIG. 5 is less than a distance threshold, it is displayed that the first virtual object 501 picks up the third virtual resource 502, and then (2) of FIG. 5 is displayed, wherein a countdown control 503 is displayed, that is, a remaining time during which the first virtual prop held by the first virtual object has a gain is 10 seconds(s).

In the embodiments, by displaying the countdown control, the game player perceives the remaining time during which the first virtual prop held by the first virtual object has a gain, which allows the game player to clearly understand the state of the first virtual prop, to arrange game strategies and actions reasonably and give full play to the maximum benefit of the first virtual prop.

In some embodiments, a progress bar is further displayed in the game interface, and the progress bar is configured to indicate the progress of the first virtual object in the scene exploration task. As illustrated in FIGS. 3, 309 represents the progress bar. It can be learned from the progress bar 309 that the progress of the first virtual object in the scene exploration task is 22%. That is, the first virtual object has completed 22% of the scene exploration task.

In the embodiments, by displaying the progress bar, the game player intuitively understands the progress of the scene exploration task, thereby better planning the game behavior and expecting the game result.

In some embodiments, an energy bar is further displayed in the game interface, and the energy bar is configured to indicate the remaining energy of the first virtual prop held by the first virtual object. In a case where the remaining energy of the first virtual prop held by the first virtual object is not less than an energy threshold, the first virtual object performs the scene exploration task by the first virtual prop. As illustrated in FIGS. 3, 310 represents the energy bar. It can be learned from the energy bar 310 that the remaining energy of the first virtual prop held by the first virtual object is 61.

The energy threshold is defined empirically, or is flexibly adjusted based on an implementation environment, which is not limited in the embodiments of the present disclosure. Exemplarily, the energy threshold is 0.

In the embodiments, by displaying the energy bar, the game player perceives the remaining energy of the first virtual prop held by the first virtual object, which allows the game player to know whether the first virtual object is capable of performing the scene exploration task by the first virtual prop.

In some embodiments, an increase control is further displayed in the game interface, and the increase control is configured to indicate the increase in the remaining energy of the first virtual prop held by the first virtual object. In some embodiments, the increase control is displayed in the energy bar. As illustrated in FIGS. 3, 311 represents the increase control. In response to a trigger operation for the increase control, the remaining energy of the first virtual prop held by the first virtual object is increased by a first amount. The first amount is defined empirically, or is flexibly adjusted based on an implementation environment, which is not limited in the embodiments of the present disclosure. Exemplarily, the first amount is 10.

Exemplarily, the remaining energy of the first virtual prop held by the first virtual object is 61. In response to the trigger operation for the increase control, the remaining energy of the first virtual prop held by the first virtual object is increased by 10, and then the remaining energy of the first virtual prop held by the first virtual object is changed to 71.

In the embodiments, by displaying the increase control, a method for increasing the remaining energy of the first virtual prop held by the first virtual object is provided for the game player, which makes the use time of the first virtual prop held by the first virtual object longer, thereby extending the game time and enhancing the game fun.

In some embodiments, the scene temperature of the virtual scene is further displayed in the game interface. As illustrated in FIGS. 3, 312 represents the scene temperature of the virtual scene, that is, the scene temperature of the virtual scene is 14.0 degrees Fahrenheit (°F).

In the embodiments, the scene temperature of the virtual scene is displayed in the game interface, which allows the game player to gain a better understanding of the virtual scene, enhancing the sense of reality and immersion of the game, helping the game player to better integrate into the game world, and also providing a reference for the game strategy.

In some embodiments, the resource information of the virtual resource and the number of virtual resources that have been collected by a resource collection prop corresponding to the first virtual object are further displayed in the game interface. The resource information of the virtual resource includes, but is not limited to, the icon of the virtual resource, the name of the virtual resource, and the like. The resource collection prop corresponding to the first virtual object is a backpack on the back of the first virtual object, or other props equipped with the first virtual object, which is not limited in the embodiments of the present disclosure. As illustrated in FIG. 3, 313 represents the resource information of the virtual resource, and “16” represents the number of virtual resources that have been collected by the resource collection prop corresponding to the first virtual object. That is, the resource collection prop corresponding to the first virtual object has collected 16 virtual resources.

In the embodiments, by displaying the resource information of the virtual resource and the number of virtual resources that have been collected by the resource collection prop corresponding to the first virtual object, the game player intuitively understands the number of virtual environments that have been collected by the first virtual object, to reasonably allocate and use the virtual resources based on game requirements.

In some embodiments, a distance element is further displayed in the game interface, the distance element is configured to indicate the distance between the first virtual object and a resource-consuming equipment, and the resource-consuming equipment is configured to consume the virtual resource collected by the first virtual object. As illustrated in FIG. 3, 314 represents the distance element, and 10 m is displayed in the distance element 314, that is, the distance between the first virtual object and the resource-consuming equipment is 10 m.

In the embodiments, by displaying the distance element, the game player is informed of the distance between the first virtual object and the resource-consuming equipment, which allows the game player to play the game in a more immersive way.

In some embodiments, the distance element further includes an arrow, and the arrow is configured to indicate the direction of the resource-consuming equipment relative to the first virtual object. As illustrated in FIG. 3, 315 represents the arrow, that is, the resource-consuming equipment is in the northwest direction of the first virtual object.

In step 202, in a case where a first condition is fulfilled, movement of the virtual resource from the position where the virtual resource is located to a resource collection prop corresponding to the first virtual object is displayed.

In some embodiments, the first condition is that the distance between the first virtual object and the virtual resource is less than a distance threshold. In some embodiments, a control is further displayed in the game interface. In a case where the first virtual object is a virtual object controlled by the game player, the control is configured to control the first virtual object to move in the virtual scene. As illustrated in FIG. 3, 316 represents the control. In response to a drag operation for the control, a movement operation for the first virtual object is triggered, and then a master virtual object is controlled to move in the virtual scene in a direction corresponding to the movement operation. The direction corresponding to the movement operation is a direction corresponding to the drag operation for the control.

In some embodiments, in response to a leftward drag operation for the control, the first virtual object is controlled to move leftward in the virtual scene. In response to a rightward drag operation for the control, the first virtual object is controlled to move rightward in the virtual scene. In response to a downward drag operation for the control, the first virtual object is controlled to move downward in the virtual scene. In response to an upward drag operation for the control, the first virtual object is controlled to move upward in the virtual scene. In response to a drag operation in another direction for the control, the first virtual object is controlled to move in the virtual scene in the another direction.

In some embodiments, in a case where the distance between the first virtual object and the virtual resource is less than the distance threshold, the movement of the virtual resource from the position where the virtual resource is located to the resource collection prop corresponding to the first virtual object is displayed.

By displaying the movement of the virtual resource from the position where the virtual resource is located to the resource collection prop corresponding to the first virtual object, the process of the first virtual object picking up the virtual resource is reflected, which allows the game player to fully experience the resource acquisition, thereby enhancing the immersion of the game.

In step 203, in a case where a second condition is fulfilled, upgrade of resource-consuming equipment with virtual resources that have been collected by the resource collection prop corresponding to the first virtual object is displayed, to adjust or maintain an environmental parameter for the first virtual object to survive within a target area affected by the resource-consuming equipment.

The second condition includes one of: the number of virtual resources that have been collected by the resource collection prop corresponding to the first virtual object being not less than a number threshold, wherein the number threshold indicates the number of virtual resources required by the resource-consuming equipment to upgrade from the current level to the next level; the number of virtual resources that have been collected by the resource collection prop corresponding to the first virtual object being not less than the number threshold, and the first virtual object being within a reference area, wherein the reference area is determined based on the position where the resource-consuming equipment is located; the number of virtual resources that have been collected by the resource collection prop corresponding to the first virtual object being not less than the number threshold, and the scene environment of the virtual scene changing; or the number of virtual resources that have been collected by the resource collection prop corresponding to the first virtual object being not less than the number threshold, and a second virtual object attacking the first virtual object, wherein the second virtual object is a hostile virtual object to the first virtual object.

In some embodiments, the resource-consuming equipment is provided with a safety area. In a case where the first virtual object is located in the safety area provided by the resource-consuming equipment, the first virtual object is not attacked by an enemy virtual object, and in a case where the first virtual object is located in the safety area provided by the resource-consuming equipment, the health points of the first virtual object will recover. The reference area is any area in the safety area provided by the resource-consuming equipment, and the safety area provided by the resource-consuming equipment is determined based on the position where the resource-consuming equipment is located and the level of the resource-consuming equipment. In some embodiments, the safety area provided by the resource-consuming equipment is a circle with the position where the resource-consuming equipment is located as the center of the circle and a second number as a radius. The second number is a number corresponding to the level of the resource-consuming equipment.

The higher the level of the resource-consuming equipment, the larger the second number, and the larger the safety area provided by the resource-consuming equipment. Exemplarily, in a case where the level of the resource-consuming equipment is level 1, the second number is 1 m, and in a case where the level of the resource-consuming equipment is level 2, the second number is 2 m. As illustrated in FIG. 3, 317 represents the resource-consuming equipment, 318 represents the safety area provided by the resource-consuming equipment, and 319 represents the reference area.

In some embodiments, the change in the scene environment of the virtual scene means that the changed scene environment of the virtual scene is different from the scene environment of the virtual scene prior to the change. The scene environment refers to the weather condition of the scene, or the color of the scene, or other information about the scene. Exemplarily, the scene environment of the virtual scene prior to the change is sunny weather, and the changed scene environment of the virtual scene is snowstorm weather.

In the embodiments, a plurality of second conditions are provided, such that preconditions for upgrading the resource-consuming equipment are diversified, thereby improving the flexibility of upgrading the resource-consuming equipment.

In some embodiments, upon display of the movement of the virtual resource from the position where the virtual resource is located to the resource collection prop corresponding to the first virtual object, the number of virtual resources that have been collected by the resource collection prop corresponding to the first virtual object is adjusted, and then the adjusted number of virtual resources that have been collected by the resource collection prop corresponding to the first virtual object is displayed. In some embodiments, 1 is added to the number of virtual resources that have been collected by the resource collection prop corresponding to the first virtual object to obtain the adjusted number of virtual resources that have been collected by the resource collection prop corresponding to the first virtual object.

Exemplarily, the number of virtual resources that have been collected by the resource collection prop corresponding to the first virtual object is 16. Upon display of the movement of the virtual resource from the position where the virtual resource is located to the resource collection prop corresponding to the first virtual object, 1 is added to the number (16) of virtual resources that have been collected by the resource collection prop corresponding to the first virtual object to obtain an adjusted number (17) of virtual resources that have been collected by the resource collection prop corresponding to the first virtual object, and then the adjusted number (17) of virtual resources that have been collected by the resource collection prop corresponding to the first virtual object is displayed.

In some embodiments, upon display of the movement of the virtual resource from the position where the virtual resource is located to the resource collection prop corresponding to the first virtual object, in a case where the number of virtual resources that have been collected by the resource collection prop corresponding to the first virtual object is not less than the number threshold, a prompt control is displayed, and the prompt control indicates that the resource-consuming equipment is upgradable. The number threshold indicates the number of virtual resources required by the resource-consuming equipment to upgrade from the current level to the next level. The resource-consuming equipment upgrade is the equipment level upgrade of the resource-consuming equipment, or the operation level upgrade of the resource-consuming equipment, which is not limited in the embodiments of the present disclosure.

Exemplarily, the number of virtual resources required by the resource-consuming equipment to upgrade from the current level to the next level is 17, and the number of virtual resources that have been collected by the resource collection prop corresponding to the first virtual object is 17. Since the number of virtual resources that have been collected by the resource collection prop corresponding to the first virtual object is the same as the number of virtual resources required by the resource-consuming equipment to upgrade from the current level to the next level, the prompt control is displayed.

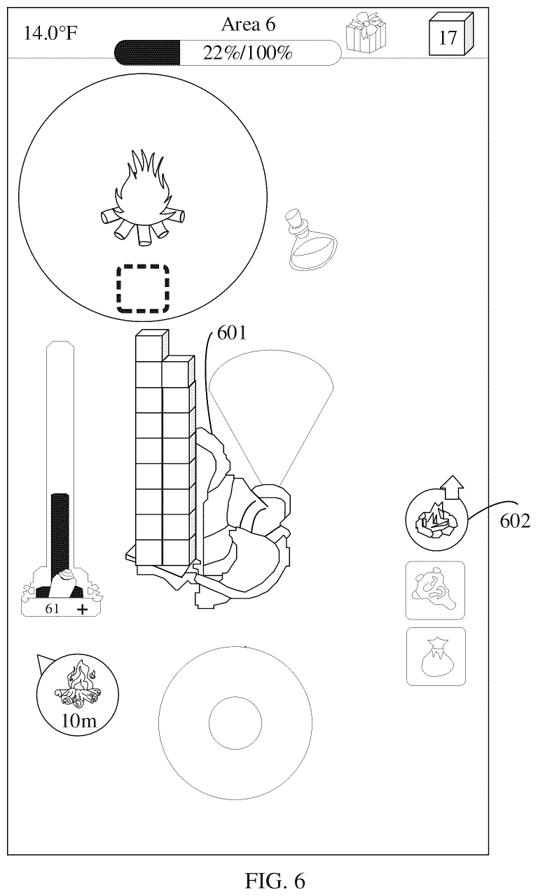

FIG. 6 is a schematic diagram of a prompt control according to some embodiments of the present disclosure. The number of virtual resources that have been collected by the resource collection prop corresponding to a first virtual object 601 is 17, which is the same as the number of virtual resources required by the resource-consuming equipment to upgrade from the current level to the next level, and therefore, a prompt control 602 is displayed.

In the embodiments, in a case where the number of virtual resources that have been collected by the resource collection prop corresponding to the first virtual object is not less than the number threshold, the prompt control is displayed to indicate that the game player is capable of upgrading the resource-consuming equipment.

In some embodiments, upon display of the prompt control, in response to a trigger operation for the prompt control, an indication element is displayed, and the indication element indicates the direction of the resource-consuming equipment relative to the first virtual object.

In some embodiments, the indication element is an arrow with the position where the first virtual object is located as a starting point, and the arrow points to the resource-consuming equipment.

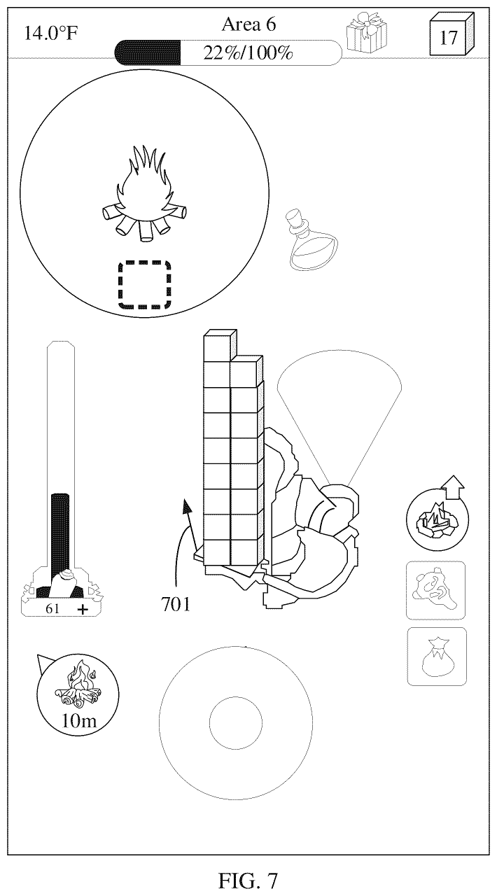

FIG. 7 is a schematic diagram of an indication element according to some embodiments of the present disclosure, wherein an indication element 701 is displayed.

In the embodiments, by displaying the indication element, the game player knows a direction in which the resource-consuming equipment is located relative to the first virtual object, thereby helping the game player control the first virtual object to move towards the resource-consuming equipment.

In some embodiments, in the case where the second condition is fulfilled, the upgrade of the resource-consuming equipment with the virtual resources that have been collected by the resource collection prop corresponding to the first virtual object is displayed, to adjust or maintain the environmental parameter for the first virtual object to survive within the target area affected by the resource-consuming equipment. In some embodiments, in the case where the second condition is fulfilled, movement of virtual resources that have been collected by the resource collection prop corresponding to the first virtual object to the resource-consuming equipment is displayed, to upgrade the resource-consuming equipment, thereby adjusting or maintaining the environmental parameter for the first virtual object to survive within the target area affected by the resource-consuming equipment based on the level of the upgraded resource-consuming equipment.

The target area affected by the resource-consuming equipment is the safety area provided by the resource-consuming equipment, or the virtual scene, which is not limited in the embodiments of the present disclosure. The environmental parameter for the first virtual object to survive within the target area affected by the resource-consuming equipment includes the size of the safety area provided by the resource-consuming equipment.

In some embodiments, the environmental parameter for the first virtual object to survive within the target area affected by the resource-consuming equipment further includes the scene temperature of the virtual scene and the health point recovery speed of the first virtual object in a case where the first virtual object is within the safety area provided by the resource-consuming equipment.

In some embodiments, in a case where a second condition is fulfilled, the upgrade o the resource-consuming equipment with the virtual resources that have been collected by the resource collection prop corresponding to the first virtual object is displayed, to adjust the environmental parameter for the first virtual object to survive within the target area affected by the resource-consuming equipment. The environmental parameter for the first virtual object to survive within the target area affected by the resource-consuming equipment upon the upgrade of the resource-consuming equipment is more favorable than the environmental parameter for the first virtual object to survive within the target area affected by the resource-consuming equipment prior to the upgrade of the resource-consuming equipment.

For example, the size of the safety area provided by the resource-consuming equipment upon the upgrade of the resource-consuming equipment is greater than the size of the safety area provided by the resource-consuming equipment prior to the upgrade of the resource-consuming equipment. For another example, the scene temperature of the virtual scene upon the upgrade of the resource-consuming equipment is higher than the scene temperature of the virtual scene prior to the upgrade of the resource-consuming equipment. For yet another example, the health point recovery speed of the first virtual object in a case where the first virtual object is located in the safety area provided by the resource-consuming equipment upon the upgrade of the resource-consuming equipment is greater than the health point recovery speed of the first virtual object in a case where the first virtual object is within the safety area provided by the resource-consuming equipment prior to the upgrade of the resource-consuming equipment.

In the embodiments, in upgrading the resource-consuming equipment, the environmental parameter for the first virtual object to survive within the target area affected by the resource-consuming equipment is adjusted, such that the adjusted environmental parameter is more favorable than the environmental parameter prior to the adjustment, and the adjusted environmental parameter is more suitable for the first virtual object to survive, making the survival efficiency of the first virtual object higher.

In some embodiments, upon the upgrade of the resource-consuming equipment, the level of the upgraded resource-consuming equipment is determined based on the number of virtual resources that have been collected by the resource collection prop corresponding to the first virtual object. Upon the upgrade of the resource-consuming equipment, the environmental parameter for the first virtual object to survive within the target area affected by the resource-consuming equipment is determined based on the level of the upgraded resource-consuming equipment.

In some embodiments, the process of determining the level of the upgraded resource-consuming equipment based on the number of the virtual resources that have been collected by the resource collection prop corresponding to the first virtual object includes: determining a level corresponding to the number of the virtual resources that have been collected by the resource collection prop corresponding to the first virtual object; and using the level corresponding to the number of the virtual resources that have been collected by the resource collection prop corresponding to the first virtual object as the level of the upgraded resource-consuming equipment.

Exemplarily, the number of virtual resources that have been collected by the resource collection prop corresponding to the first virtual object is 17, and a level corresponding to 17 is level 3, such that the level of the upgraded resource-consuming equipment is level 3.

Alternatively, the process of determining the level of the upgraded resource-consuming equipment based on the number of the virtual resources that have been collected by the resource collection prop corresponding to the first virtual object includes: determining the sum value of a level corresponding to the number of the virtual resources that have been collected by the resource collection prop corresponding to the first virtual object and the current level of the resource-consuming equipment, and using the sum value as the level of the upgraded resource-consuming equipment.

Exemplarily, the number of virtual resources that have been collected by the resource collection prop corresponding to the first virtual object is 17, a level corresponding to 17 is level 3, and the current level of the resource-consuming equipment is level 2, such that the level of the upgraded resource-consuming equipment is level 5.

Upon the upgrade of the resource-consuming equipment, in adjusting the environmental parameter for the first virtual object to survive within the target area affected by the resource-consuming equipment, the environmental parameter for the first virtual object to survive within the target area affected by the resource-consuming equipment needs to be first determined based on the level of the upgraded resource-consuming equipment, and then adjusted based on the environmental parameter determined based on the level of the upgraded resource-consuming equipment. The process of determining the environmental parameter for the first virtual object to survive within the target area affected by the resource-consuming equipment based on the level of the upgraded resource-consuming equipment is not limited in the embodiments of the present disclosure. Exemplarily, the process of determining the environmental parameter for the first virtual object to survive within the target area affected by the resource-consuming equipment based on the level of the upgraded resource-consuming equipment includes: determining, in a case where the environmental parameter for the first virtual object to survive within the target area affected by the resource-consuming equipment includes the size of the safety area provided by the resource-consuming equipment, a fourth area based on the level of the upgraded resource-consuming equipment, wherein the fourth area is the safety area provided by the resource-consuming equipment upon the upgrade of the resource-consuming equipment. In a case where the environmental parameter for the first virtual object to survive within the target area affected by the resource-consuming equipment includes the scene temperature of the virtual scene, a target temperature is determined based on the level of the upgraded resource-consuming equipment, wherein the target temperature is the scene temperature of the virtual scene upon the upgrade of the resource-consuming equipment. In a case where the environmental parameter for the first virtual object to survive within the target area affected by the resource-consuming equipment includes the health point recovery speed of the first virtual object in a case where the first virtual object is within the safety area provided by the resource-consuming equipment, a target recovery speed is determined based on the level of the upgraded resource-consuming equipment, wherein the target recovery speed is the health point recovery speed of the first virtual object in a case where the first virtual object is within the safety area provided by the resource-consuming equipment upon the upgrade of the resource-consuming equipment.

The process of determining the fourth area based on the level of the upgraded resource-consuming equipment includes: determining a second length corresponding to the level of the upgraded resource-consuming equipment; and determining the fourth area based on the position where the resource-consuming equipment is located and the second length. Exemplarily, an area, covered by a circle with the position where the resource-consuming equipment is located as the center of the circle and the second length as a radius, is determined as the fourth area.

In some embodiments, the process of determining the target temperature based on the level of the upgraded resource-consuming equipment includes: determining a temperature corresponding to the level of the upgraded resource-consuming equipment as the target temperature. Exemplarily, the level of the upgraded resource-consuming equipment is level 2, and a temperature corresponding to level 2 is 23 °F; then the target temperature is 23 °F.

In some other embodiments, the target temperature is determined based on the temperature corresponding to the level of the upgraded resource-consuming equipment and the scene temperature of the virtual scene. In some embodiments, the sum value of the temperature corresponding to the level of the upgraded resource-consuming equipment and the scene temperature of the virtual scene is determined as the target temperature.

Exemplarily, the level of the upgraded resource-consuming equipment is level 2, a temperature corresponding to level 2 is 9 °F, and the temperature of the scene equipment in the virtual scene is 14 °F; then the target temperature is 9+14=23 °F.

In the embodiments, two methods for determining the target temperature are provided, such that the target temperature is determined more flexibly and in various ways.

In some embodiments, the process of determining the target recovery speed based on the level of the upgraded resource-consuming equipment includes: determining a recovery speed corresponding to the level of the upgraded resource-consuming equipment as the target recovery speed.

Exemplarily, the level of the upgraded resource-consuming equipment is level 2, and a recovery speed corresponding to level 2 is 10 points per second; then the target recovery speed is 10 points per second. That is, in a case where the first virtual object is within the safety area provided by the resource-consuming equipment, the health points of the first virtual object are recovered by 10 points per second.

In the embodiments, the level of the upgraded resource-consuming equipment is determined based on the number of virtual resources that have been collected by the resource collection prop corresponding to the first virtual object, such that the process of determining the level of the upgraded resource-consuming equipment is more reasonable, and the accuracy of the determined level of the upgraded resource-consuming equipment is higher. In addition, upon the upgrade of the resource-consuming equipment, the environmental parameter for the first virtual object to survive within the target area affected by the resource-consuming equipment is determined based on the level of the upgraded resource-consuming equipment, such that the accuracy of the determined environmental parameter for the first virtual object to survive within the target area affected by the resource-consuming equipment is higher.

In some embodiments, upon determination of the target temperature, the scene temperature of the virtual scene is further updated to display the target temperature.

In the embodiments, by displaying the target temperature, the game player knows that the resource-consuming equipment has been upgraded, and the game player knows the temperature of the virtual scene upon the upgrade of the resource-consuming equipment, thereby enhancing the sense of reality and immersion of the game.

In some embodiments, upon determination of the fourth area, the fourth area is further displayed in a second form, which allows the game player to perceive the change in the safety area provided by the resource-consuming equipment. Exemplarily, the fourth area is displayed in a light-emitting form, to represent that the fourth area is the safety area provided by the resource-consuming equipment.

In some embodiments, in a case where the second condition is fulfilled and the virtual scene changes from a first scene environment to a second scene environment, the upgrade of the resource-consuming equipment with the virtual resources that have been collected by the resource collection prop corresponding to the first virtual object is displayed, to maintain the environmental parameter for the first virtual object to survive within the target area affected by the resource-consuming equipment. The environmental parameter for the first virtual object to survive within the target area affected by the resource-consuming equipment upon the upgrade of the resource-consuming equipment is the same as the environmental parameter for the first virtual object to survive within the target area affected by the resource-consuming equipment prior to the upgrade of the resource-consuming equipment, and the second scene environment is harsher than the first scene environment. That is, in a case where the second condition is met and the scene environment of the virtual scene deteriorates, upon the upgrade of the resource-consuming equipment, the environmental parameter for the first virtual object to survive within the target area affected by the resource-consuming equipment does not change.

For example, the size of the safety area provided by the resource-consuming equipment upon the upgrade of the resource-consuming equipment is the same as the size of the safety area provided by the resource-consuming equipment prior to the upgrade of the resource-consuming equipment. For another example, the scene temperature of the virtual scene upon the upgrade of the resource-consuming equipment is the same as the scene temperature of the virtual scene prior to the upgrade of the resource-consuming equipment. For yet another example, the health point recovery speed of the first virtual object in a case where the first virtual object is within the safety area provided by the resource-consuming equipment upon the upgrade of the resource-consuming equipment is the same as the health point recovery speed of the first virtual object in a case where the first virtual object is within the safety area provided by the resource-consuming equipment prior to the upgrade of the resource-consuming equipment.

In the embodiments, in a case where the second condition is met and the scene environment of the virtual scene deteriorates, the resource-consuming equipment is upgraded to maintain the environmental parameter for the first virtual object to survive within the target area affected by the resource-consuming equipment, such that in a case where the scene environment changes, the environmental parameter for the first virtual object to survive does not change, and thus the control strategy of the first virtual object does not need to be adjusted due to the change in the environmental parameter. This helps the game player maintain the game rhythm, thereby improving the game experience of the game player.

In some embodiments, upon display of the upgrade of the resource-consuming equipment with the virtual resources that have been collected by the resource collection prop corresponding to the first virtual object, in a case where the appearance of the upgraded resource-consuming equipment is different from the appearance of the resource-consuming equipment prior to the upgrade, the upgraded resource-consuming equipment is further displayed. In some embodiments, the appearance of the upgraded resource-consuming equipment is more luxurious than the appearance of the resource-consuming equipment prior to the upgrade.

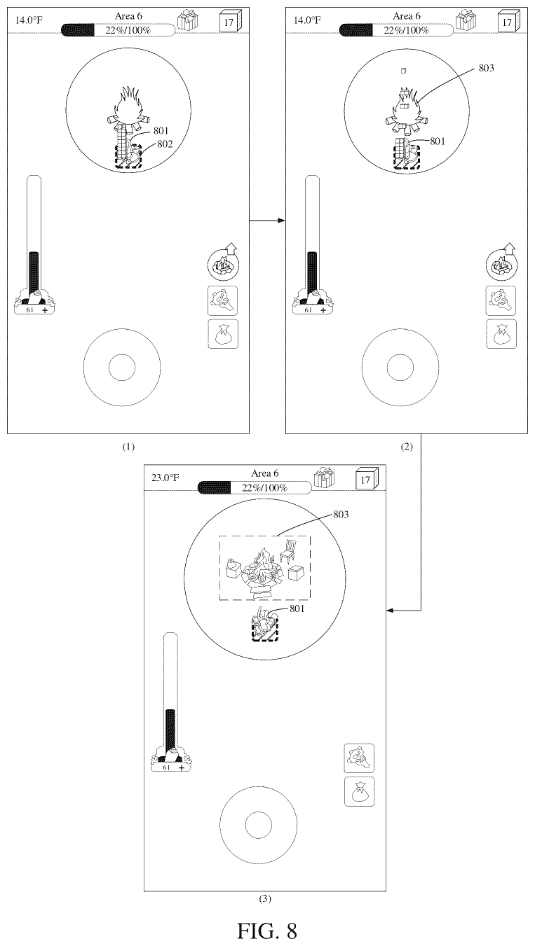

FIG. 8 is a schematic diagram of upgrading resource-consuming equipment from virtual resources that have been collected by a resource collection prop corresponding to a first virtual object according to some embodiments of the present disclosure. In (1) of FIG. 8, a first virtual object 801 is within a reference area 802, and the number of virtual resources that have been collected by the resource collection prop corresponding to the first virtual object 801 is not less than the number threshold; then (2) of FIG. 8 is displayed, wherein movement of the virtual resources that have been collected by the resource collection prop corresponding to the first virtual object 801 to resource-consuming equipment 803 is displayed. In a case where the virtual resources that have been collected by the resource collection prop corresponding to the first virtual object 801 move to the resource-consuming equipment 803, (3) of FIG. 8 is displayed. The size of the safety area provided by the resource-consuming equipment 803 changes (the safety area provided by the resource-consuming equipment 803 becomes larger), the appearance of the resource-consuming equipment 803 changes (the appearance of the resource-consuming equipment 803 becomes more luxurious), and the scene temperature of the virtual scene changes (the scene temperature of the virtual scene changes from 14 °F to 23 °F).

In the embodiments, by displaying the upgraded resource-consuming equipment, the game player perceives that the resource-consuming equipment has been upgraded, and the upgrade process of the resource-consuming equipment is visualized.

In some embodiments, in a case where the first virtual object is within the reference area, the reference area is displayed in a first form. The first form is set based on experience, or is adjusted based on an implementation environment, which is not limited in the embodiments of the present disclosure. Exemplarily, displaying in the first form is displaying in a shadow form. As illustrated in (1) of FIG. 8, the first virtual object 801 is within the reference area 802, and the reference area 802 is displayed in the shadow form.

In some embodiments, upon movement of the virtual resources that have been collected by the resource collection prop corresponding to the first virtual object to the resource-consuming equipment, the display of the prompt control is canceled since the resource collection prop corresponding to the first virtual object no longer has the virtual resource. As illustrated in (3) of FIG. 8, the resource collection prop corresponding to the first virtual object 801 no longer has the virtual resource, and the prompt control is not displayed therein.

In some embodiments, upon display of the upgrade of the resource-consuming equipment with the virtual resources that have been collected by the resource collection prop corresponding to the first virtual object, a first area is displayed in a target form. The first area is determined based on the position where the first virtual object is located and the level of the upgraded resource-consuming equipment, and the target form is configured to indicate that the first virtual object is not attacked by a second virtual object in a case where the first virtual object is within the first area, the second virtual object being a hostile virtual object to the first virtual object.

In some embodiments, the process of determining the first area based on the position where the first virtual object is located and the level of the upgraded resource-consuming equipment includes: determining a third number corresponding to the level of the upgraded resource-consuming equipment, and determining an area, covered by a circle with the position where the first virtual object is located as the center of the circle and the third number as a radius, as the first area.

The target form may be any form, which is not limited in the embodiments of the present disclosure. In some embodiments, the target form is a shadow form, the target form is displayed in black, and the target form is also a light-emitting form.

In a case where the first area is displayed in the target form, the game player may know that in a case where the first virtual object is within the first area displayed in the target form, the first virtual object may not be attacked by an enemy virtual object, such that the health points of the first virtual object may be kept, and thus the survival rate of the first virtual object may be increased.

In some embodiments, upon display of the upgrade of the resource-consuming equipment with the virtual resources that have been collected by the resource collection prop corresponding to the first virtual object, the application range of the first virtual prop is further adjusted. The adjusted application range of the first virtual prop is greater than the application range of the first virtual prop prior to the adjustment. In this way, the first virtual object performs the scene exploration task by using the first virtual prop with a larger application range, to accelerate the completion of the scene exploration task by the first virtual object.

In some embodiments, the adjusted application range of the first virtual prop is determined based on the level of the upgraded resource-consuming equipment.

In some embodiments, upon the upgrade of the resource-consuming equipment, a second virtual prop is further transferred to the control object of the first virtual object. The second virtual prop is configured to determine the temperature of a second area as a reference temperature in a case where the first virtual object is equipped with the second virtual prop, wherein the second area is determined based on the position where the first virtual object is located, and the reference temperature is determined based on the second virtual prop.

In some embodiments, the reference temperature is a temperature corresponding to the second virtual prop. For example, the reference temperature is 59 °F.

The second area is an area determined based on the position where the first virtual object is located. In some embodiments, the second virtual area is an area covered by a circle with the position where the first virtual object is located as the center of the circle. The method for determining the second area is not limited in the embodiments of the present disclosure.

In the embodiments, by transferring one second virtual prop to the control object of the first virtual object, in a case where the first virtual object is equipped with the second virtual prop, the temperature of the second area where the first virtual object is located is the reference temperature, thereby ensuring that the first virtual object is at a comfortable temperature, to help the first virtual object better perform the scene exploration task.

In some embodiments, upon the upgrade of the resource-consuming equipment, a third area is determined based on the position of the resource-consuming equipment and the adjusted level of the resource-consuming equipment, wherein the third area is greater than the safety area provided by the upgraded resource-consuming equipment. Movement of a virtual resource within the third area from the position of the virtual resource to the resource collection prop corresponding to the first virtual object is displayed.

The method for determining the third area is not limited in the embodiments of the present disclosure. Exemplarily, an area, covered by a circle with the position of the resource-consuming equipment as the center of the circle and a value corresponding to the adjusted level of the resource-consuming equipment as a radius, is determined as the third area.

In the embodiments, the virtual resource within the third area is automatically moved to the resource collection prop corresponding to the first virtual object, such that the first virtual object does not need to be moved to acquire the virtual resource, thereby achieving a higher efficiency of acquiring the virtual resource.

According to the above method, the game player controls the first virtual object to move in the virtual scene, and in a case where the first condition is fulfilled, movement of the virtual resource from the position where the virtual resource is located to the resource collection prop corresponding to the first virtual object is displayed, to visualize the process of the first virtual object collecting the virtual resource. In a case where the second condition is fulfilled, the resource-consuming equipment is upgraded with the virtual resources collected by the first virtual object, to adjust or maintain the environmental parameter for the first virtual object to survive within the target area affected by the resource-consuming equipment. In this way, the game player can not only collect virtual resources in the virtual scene, but also consume the virtual resources to upgrade the resource-consuming equipment, such that the interaction modes of the virtual objects are diversified, the interaction modes are more flexible, and the interaction rate of the virtual objects is increased, thereby enriching the gameplay of the game. As a result, the playability of the game is higher, the interactive fun of the game is increased, and thus the player's sense of participation and achievement in the game is enhanced, thereby improving the interactivity and user retention rate of the game.

In some embodiments of the present disclosure, a first virtual object within a virtual scene is displayed, the virtual scene is covered by a granular covering, the first virtual object holds a first virtual prop, and the first virtual prop is configured to clear the granular covering in the application range of the first virtual prop; in a case where the first virtual object clears the granular covering in the application range of the first virtual prop by the first virtual prop, and a virtual resource (coal briquette) exists in the application range of the first virtual prop, the virtual resource is displayed. The first virtual object is controlled to move towards the virtual resource, and in a case where the distance between the first virtual object and the virtual resource is less than a distance threshold, movement of the virtual resource from the position where the virtual resource is located to a resource collection prop corresponding to the first virtual object (a backpack of the first virtual object) is displayed. In a case where the number of virtual resources that have been collected by the resource collection prop corresponding to the first virtual object is not less than a number threshold, and the first virtual object is within a reference area, movement of the virtual resources that have been collected by the resource collection prop corresponding to the first virtual object to resource-consuming equipment (a furnace) is displayed, to upgrade the resource-consuming equipment. Upon the upgrade of the resource-consuming equipment, the size of the safety area provided by the resource-consuming equipment is adjusted, and the scene temperature of the virtual scene is adjusted.

The number threshold indicates the number of virtual resources required by the resource-consuming equipment to upgrade from the current level to the next level. The reference area is any area within the safety area provided by the resource-consuming equipment. The safety area provided by the resource-consuming equipment upon the upgrade of the resource-consuming equipment is larger than the safety area provided by the resource-consuming equipment prior to the upgrade of the resource-consuming equipment. The scene temperature of the virtual scene upon the upgrade of the resource-consuming equipment is higher than the scene temperature of the virtual scene prior to the upgrade of the resource-consuming equipment.

In a case where the number of virtual resources that have been collected by the resource collection prop corresponding to the first virtual object is not less than the number threshold, the first virtual object is within the reference area, and the virtual scene changes from a first scene environment to a second scene environment, movement of the virtual resources that have been collected by the resource collection prop corresponding to the first virtual object to resource-consuming equipment (a furnace) is displayed, to upgrade the resource-consuming equipment. Upon the upgrade of the resource-consuming equipment, the size of the safety area provided by the resource-consuming equipment and the scene temperature of the virtual scene do not change. The second scene environment is harsher than the first scene environment. For example, the second scene environment is snowstorm weather, and the first scene environment is sunny weather.

That is, the size of the safety area provided by the resource-consuming equipment upon the upgrade of the resource-consuming equipment is the same as the size of the safety area provided by the resource-consuming equipment prior to the upgrade of the resource-consuming equipment. The scene temperature of the virtual scene upon the upgrade of the resource-consuming equipment is the same as the scene temperature of the virtual scene prior to the upgrade of the resource-consuming equipment.

FIG. 9 is a schematic structural diagram of an apparatus for virtual object interaction according to some embodiments of the present disclosure. As illustrated in FIG. 9, the apparatus includes: a displaying module 901, configured to display a first virtual object and a virtual resource within a virtual scene.

The displaying module 901 is further configured to display, in a case where a first condition is fulfilled, that the virtual resource moves from the position where the virtual resource is located to a resource collection prop corresponding to the first virtual object.

The displaying module 901 is further configured to display, in a case where a second condition is fulfilled, upgrade of resource-consuming equipment with virtual resources that have been collected by the resource collection prop corresponding to the first virtual object, to adjust or maintain an environmental parameter for the first virtual object to survive within a target area affected by the resource-consuming equipment.

In some embodiments, the displaying module 901 is configured to: display, in a case where a second condition is fulfilled, upgrade of resource-consuming equipment with virtual resources that have been collected by the resource collection prop corresponding to the first virtual object, to adjust an environmental parameter for the first virtual object to survive within a target area affected by the resource-consuming equipment, wherein the environmental parameter for the first virtual object to survive within the target area affected by the resource-consuming equipment upon the upgrade of the resource-consuming equipment is more favorable than the environmental parameter for the first virtual object to survive within the target area affected by the resource-consuming equipment prior to the upgrade of the resource-consuming equipment; or display, in a case where the second condition is satisfied and the virtual scene changes from a first scene environment to a second scene environment, the upgrade of the resource-consuming equipment with the virtual resources that have been collected by the resource collection prop corresponding to the first virtual object, to maintain the environmental parameter for the first virtual object to survive within the target area affected by the resource-consuming equipment, wherein the environmental parameter for the first virtual object to survive within the target area affected by the resource-consuming equipment upon the upgrade of the resource-consuming equipment is the same as the environmental parameter for the first virtual object to survive within the target area affected by the resource-consuming equipment prior to the upgrade of the resource-consuming equipment, and the second scene environment is harsher than the first scene environment.

In some embodiments, the level of the upgraded resource-consuming equipment is determined based on the number of the virtual resources that have been collected by the resource collection prop corresponding to the first virtual object. Upon the upgrade of the resource-consuming equipment, the environmental parameter for the first virtual object to survive within the target area affected by the resource-consuming equipment is determined based on the level of the upgraded resource-consuming equipment.

In some embodiments, the environmental parameter for the first virtual object to survive within the target area affected by the resource-consuming equipment includes the scene temperature of the virtual scene; the displaying module 901 is further configured to display the scene temperature of the virtual scene; the apparatus further includes: a determining module, configured to determine a target temperature, wherein the target temperature is the scene temperature of the virtual scene upon the upgrade of the resource-consuming equipment, and the target temperature is determined based on the level of the upgraded resource-consuming equipment; and the displaying module 901 is further configured to update the displayed scene temperature of the virtual scene to the target temperature.

In some embodiments, the displaying module 901 is further configured to display a first area in a target form, wherein the first area is determined based on the position where the first virtual object is located and the level of the upgraded resource-consuming equipment, and the target form is configured to indicate that the first virtual object is not attacked by a second virtual object in a case where the first virtual object is within the first area, the second virtual object being a hostile virtual object to the first virtual object.

In some embodiments, the second condition includes one of:
the number of the virtual resources that have been collected by the resource collection prop corresponding to the first virtual object being not less than a number threshold, wherein the number threshold indicates the number of virtual resources required by the resource-consuming equipment to upgrade from the current level to the next level;
the number of the virtual resources that have been collected by the resource collection prop corresponding to the first virtual object being not less than the number threshold, and the first virtual object being within a reference area, wherein the reference area is determined based on the position where the resource-consuming equipment is located;
the number of the virtual resources that have been collected by the resource collection prop corresponding to the first virtual object being not less than the number threshold, and the scene environment of the virtual scene changing; or
the number of the virtual resources that have been collected by the resource collection prop corresponding to the first virtual object being not less than the number threshold, and a second virtual object attacks the first virtual object, wherein the second virtual object is a hostile virtual object to the first virtual object.

In some embodiments, the displaying module 901 is further configured to display, in a case where the number of the virtual resources that have been collected by the resource collection prop corresponding to the first virtual object is not less than a number threshold, a prompt control, wherein the prompt control indicates that the resource-consuming equipment is upgradable, and the number threshold indicates the number of virtual resources required by the resource-consuming equipment to upgrade from the current level to the next level.

In some embodiments, the displaying module 901 is further configured to display, in response to a trigger operation for the prompt control, an indication element, wherein the indication element indicates the direction of the resource-consuming equipment relative to the first virtual object.

In some embodiments, the displaying module 901 is further configured to display the upgraded resource-consuming equipment, wherein the appearance of the upgraded resource-consuming equipment is different from the appearance of the resource-consuming equipment prior to the upgrade.

In some embodiments, the first virtual object performs a scene exploration task in the virtual scene, the virtual scene is covered by a granular covering, the first virtual object holds a first virtual prop, and the first virtual prop is configured to eliminate the granular covering in the application range of the virtual prop; and the apparatus further includes: an adjusting module, configured to adjust the application range of the first virtual prop, wherein the adjusted application range of the first virtual prop is greater than the application range of the first virtual prop prior to the adjustment.

In some embodiments, the apparatus further includes: a transferring module, configured to transfer a second virtual prop to the control object of the first virtual object, wherein the second virtual prop is configured to determine the temperature of a second area as a reference temperature in a case where the first virtual object is equipped with the second virtual prop, wherein the second area is determined based on the position where the first virtual object is located, and the reference temperature is determined based on the second virtual prop.

In some embodiments, the apparatus further includes: a determining module, configured to determine a third area based on the position of the resource-consuming equipment and the adjusted level of the resource-consuming equipment, wherein the third area is greater than the safety area provided by the upgraded resource-consuming equipment; wherein the displaying module 901 is further configured to display movement of a virtual resource within the third area from the position of the virtual resource to the resource collection prop corresponding to the first virtual object.

According to the above apparatus, the game player controls the first virtual object to move in the virtual scene, and in the case where the first condition is fulfilled, the movement of the virtual resource from the position where the virtual resource is located to the resource collection prop corresponding to the first virtual object is displayed, to visualize the process of the first virtual object collecting the virtual resource. In the case where the second condition is fulfilled, the resource-consuming equipment is upgraded with the virtual resources collected by the first virtual object, to adjust or maintain the environmental parameter for the first virtual object to survive within the target area affected by the resource-consuming equipment. In this way, the game player can not only collect virtual resources in the virtual scene, but also consume the virtual resources to upgrade the resource-consuming equipment, such that the interaction modes of the virtual objects are diversified, the interaction modes are more flexible, and the interaction rate of the virtual objects is increased, thereby enriching the gameplay of the game. As a result, the playability of the game is higher, the interactive fun of the game is increased, and thus the player's sense of participation and achievement in the game is enhanced, thereby improving the interactivity and user retention rate of the game.

It should be noted that in a case where the above apparatus implements the functions thereof, the division of the functional modules is merely exemplary. In practical applications, the above functions can be assigned to different functional modules as needed; that is, the internal structure of the device may be divided into different functional modules, to implement all or a part of the above functions. In addition, the apparatus and the method according to the above embodiments belong to the same concept, and specific implementation processes thereof are described in the method embodiments in detail, and are not described again here.

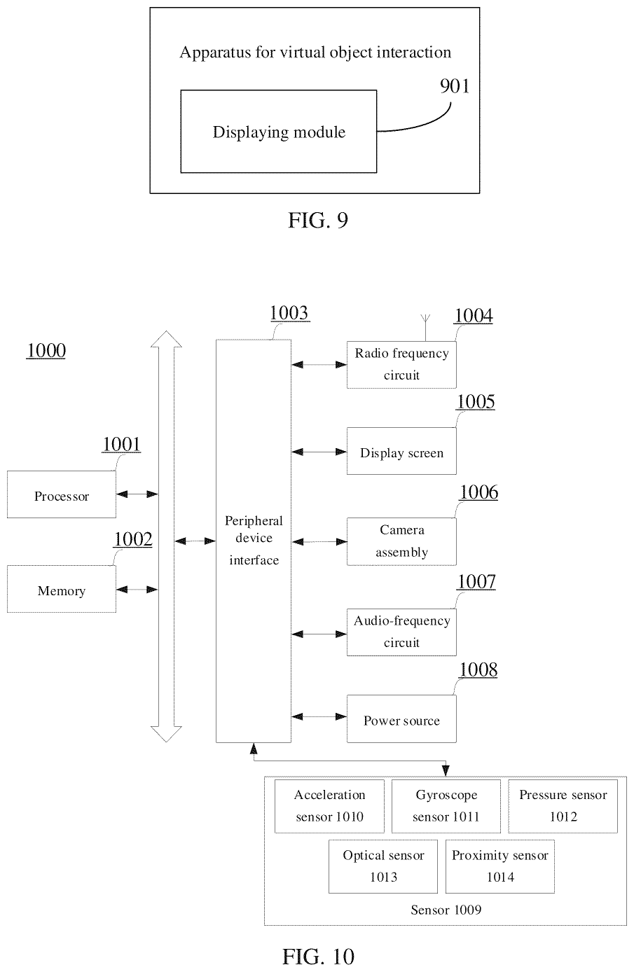

FIG. 10 shows a structural block diagram of a terminal device 1000 according to some exemplary embodiments of the present disclosure. The terminal device 1000 is any electronic device product capable of performing human-computer interaction with a user by one or more methods such as a keyboard, a touch pad, a remote control, or a voice interaction or handwriting device, for example, a PC, a mobile phone, a smart phone, a PDA, a wearable device, a PPC, a tablet computer, a smart car machine, a smart television, a smart speaker, or a smart watch.

Generally, the terminal device 1000 includes: a processor 1001 and a memory 1002.

The processor 1001 includes one or more processing cores, such as a 4-core processor and an 8-core processor. The processor 1001 is implemented in at least one hardware form of a digital signal processor (DSP), a field-programmable gate array (FPGA), or a programmable logic array (PLA). The processor 1001 further includes a main processor and a coprocessor. The main processor is a processor configured to process data in an awake state, and is also referred to as a central processing unit (CPU). The coprocessor is a low-power processor configured to process data in a standby state. In some embodiments, the processor 1001 is integrated with a graphics processing unit (GPU) that is responsible for rendering and drawing contents that need to be displayed on a display screen. In some embodiments, the processor 1001 further includes an artificial intelligence (AI) processor for processing computing operations related to machine learning.

The memory 1002 includes one or more computer-readable storage media, which are non-transitory. The memory 1002 further includes a high-speed random access memory, and a non-volatile memory, such as one or more magnetic disk storage devices and flash storage devices. In some embodiments, the non-transitory computer-readable storage medium in the memory 1002 is configured to store at least one instruction. The at least one instruction, when executed by the processor 1001, causes the processor to perform the method for virtual object interaction according to the method embodiments of the present disclosure.

In some embodiments, the terminal device 1000 further includes: a peripheral device interface 1003 and at least one peripheral device. The processor 1001, the memory 1002, and the peripheral device interface 1003 are connected via buses or signal lines. The peripheral devices are connected to the peripheral device interface 1003 via a bus, signal line, or circuit board. Specifically, the peripheral devices include: at least one of a radio frequency circuit 1004, a display screen 1005, a camera assembly 1006, an audio-frequency circuit 1007, or a power source 1008.

The peripheral device interface 1003 is configured to connect at least one peripheral device related to input/output (I/O) to the processor 1001 and the memory 1002. In some embodiments, the processor 1001, the memory 1002, and the peripheral device interface 1003 are integrated on the same chip or circuit board. In some other embodiments, any one or two of the processor 1001, the memory 1002, and the peripheral device interface 1003 are implemented on a separate chip or circuit board, which is not limited in the embodiments of the present disclosure.

The radio frequency circuit 1004 is configured to receive and transmit a radio frequency (RF) signal, which is also referred to as an electromagnetic signal. The radio frequency circuit 1004 communicates with a communication network and other communication devices via electromagnetic signals. The radio frequency circuit 1004 converts an electrical signal into an electromagnetic signal for transmission, or converts a received electromagnetic signal into an electrical signal. In some embodiments, the radio frequency circuit 1004 includes an antenna system, an RF transceiver, one or more amplifiers, a tuner, an oscillator, a digital signal processor, a codec chipset, a subscriber identity module card, and the like. The radio frequency circuit 1004 communicates with other terminal devices via at least one wireless communication protocol. The wireless communication protocol includes, but is not limited to, the World Wide Web, a metropolitan area network, an intranet, generations of mobile communication networks (2G, 3G, 4G, and 5G), a wireless local area network, and/or a wireless fidelity (Wi-Fi) network. In some embodiments, the radio frequency circuit 1004 further includes a near-field communication (NFC) related circuit, which is not limited in the present disclosure.

The display screen 1005 is configured to display a user interface (UI). The UI includes graphics, text, icons, videos, and any combination thereof. In a case where the display screen 1005 is a touch display screen, the display screen 1005 also has the capacity to acquire a touch signal on or above a surface of the display screen 1005. The touch signal is input to the processor 1001 as a control signal for processing. In this case, the display screen 1005 is also configured to provide virtual buttons and/or virtual keyboards, which are also referred to as soft buttons and/or soft keyboards. In some embodiments, there is one display screen 1005, which is disposed on a front panel of the terminal device 1000. In some other embodiments, there are at least two display screens 1005, which are disposed on different surfaces of the terminal device 1000, respectively, or in a folded design. In yet some other embodiments, the display screen 1005 is a flexible display screen disposed on a curved surface or a folded surface of the terminal device 1000. The display screen 1005 is even configured as a non-rectangular irregular pattern, that is, a special-shaped screen. The display screen 1005 is manufactured by using a material such as a liquid crystal display (LCD) or an organic light-emitting diode (OLED).

The camera assembly 1006 is configured to acquire images or videos. In some embodiments, the camera assembly 1006 includes a front camera and a rear camera. Generally, the front camera is disposed on the front panel of the terminal device 1000, and the rear camera is disposed on the back surface of the terminal device 1000. In some embodiments, there are at least two rear cameras, which are any one of a primary camera, a depth of field camera, a wide-angle camera, or a telephoto camera, such that the primary camera and the depth of field camera are combined to implement a bokeh function, the primary camera and the wide-angle camera are combined to implement panoramic shooting and virtual reality (VR) shooting functions, or other combined shooting functions are implemented. In some embodiments, the camera assembly 1006 further includes a flash. The flash is a single-color temperature flash or a two-color temperature flash. The two-color temperature flash is a combination of a warm-light flash and a cold-light flash, and is configured for light compensation at different color temperatures.

The audio-frequency circuit 1007 includes a microphone and a speaker. The microphone is configured to acquire sound waves of the user and the environment, and convert the sound waves into electrical signals for input into the processor 1001 for processing, or into the radio frequency circuit 1004 for voice communication. For the purpose of stereo acquisition or noise reduction, there are a plurality of microphones, which are disposed at different parts of the terminal device 1000, respectively. The microphone is also an array microphone or an omnidirectional acquisition microphone. The speaker is configured to convert the electrical signal from the processor 1001 or the radio frequency circuit 1004 into sound waves. The speaker is a conventional film speaker or a piezoelectric ceramic speaker. In a case where the speaker is a piezoelectric ceramic speaker, not only can the electrical signal be converted into sound waves that are audible to humans, but also the electrical signal can be converted into sound waves that are inaudible to humans for ranging and the like. In some embodiments, the audio-frequency circuit 1007 further includes a headphone jack.

The power source 1008 is configured to supply power to the components in the terminal device 1000. The power source 1008 is an alternating current, a direct current, a disposable battery, or a rechargeable battery. In a case where the power source 1008 includes a rechargeable battery, the rechargeable battery is a wired rechargeable battery or a wireless rechargeable battery. The wired rechargeable battery is a battery charged by a wired line, and the wireless rechargeable battery is a battery charged by a wireless coil. The rechargeable battery is further configured to support fast charging.

In some embodiments, the terminal device 1000 further includes one or more sensors 1009. The one or more sensors 1009 include, but are not limited to, an acceleration sensor 1010, a gyroscope sensor 1011, a pressure sensor 1012, an optical sensor 1013, and a proximity sensor 1014.

The acceleration sensor 1010 detects accelerations on three coordinate axes of a coordinate system established by the terminal device 1000. For example, the acceleration sensor 1010 is configured to detect components of the gravitational acceleration on the three coordinate axes. The processor 1001 controls the display screen 1005 to display the user interface in a landscape view or a portrait view based on a gravity acceleration signal acquired by the acceleration sensor 1010. The acceleration sensor 1010 is further configured to acquire game data or motion data of the user.

The gyroscope sensor 1011 detects a body direction and a rotation angle of the terminal device 1000, and the gyroscope sensor 1011, together with the acceleration sensor 1010, acquires a 3D motion of the user to the terminal device 1000. Based on the data acquired by the gyroscope sensor 1011, the processor 1001 implements following functions: motion sensing (for example, changing the UI based on a tilting operation of the user), image stabilization during shooting, game control, and inertial navigation.

The pressure sensor 1012 is disposed at a side frame of the terminal device 1000 and/or underneath the display screen 1005. In a case where the pressure sensor 1012 is disposed at the side frame of the terminal device 1000, a hold signal of the user to the terminal device 1000 is detected, and the processor 1001 performs left-right hand recognition or shortcut operation based on the holding signal acquired by the pressure sensor 1012. In a case where the pressure sensor 1012 is disposed underneath the display screen 1005, an operability control on the UI is controlled by the processor 1001 based on the pressure operation of the user on the display screen 1005. The operability control includes at least one of a button control, a scroll bar control, an icon control, or a menu control.

The optical sensor 1013 is configured to acquire ambient light intensity. In some embodiments, the processor 1001 controls the display luminance of the display screen 1005 based on the ambient light intensity acquired by the optical sensor 1013. Specifically, under high ambient light intensity, the display luminance of the display screen 1005 is increased; under low ambient light intensity, the display luminance of the display screen 1005 is lowered. In some other embodiments, the processor 1001 also dynamically adjusts the shooting parameters of the camera assembly 1006 based on the ambient light intensity acquired by the optical sensor 1013.

The proximity sensor 1014, also referred to as a distance sensor, is generally disposed on the front panel of the terminal device 1000. The proximity sensor 1014 is configured to acquire the distance between the user and the front surface of the terminal device 1000. In some embodiments, in a case where the proximity sensor 1014 detects that the distance between the user and the front surface of the terminal device 1000 is gradually decreasing, the processor 1001 controls the display screen 1005 to switch from a screen-on state to a screen-off state; or in a case where the proximity sensor 1014 detects that the distance between the user and the front surface of the terminal device 1000 is gradually increasing, the processor 1001 controls the display screen 1005 to switch from the screen-off state to the screen-on state.

Those skilled in the art should understand that the structure illustrated in FIG. 10 does not limit the terminal device 1000, and the terminal device may include more or fewer components than those illustrated, or some of the components may be combined, or a different arrangement of components may be employed.

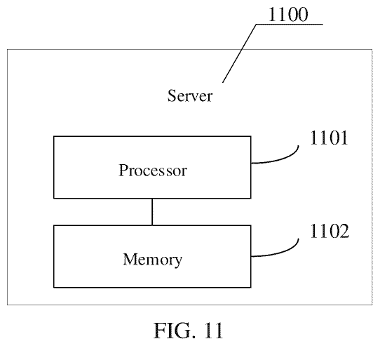

FIG. 11 is a schematic structural diagram of a server according to some embodiments of the present disclosure. The server 1100 may vary greatly due to different configurations or performance, and may include one or more processors (central processing units, CPUs) 1101 and one or more memories 1102. The one or more memories 1102 store at least one program code, and the at least one program code, when loaded and executed by the one or more processors 1101, causes the one or more processors to perform the method for virtual object interaction according to the above method embodiments. In addition, the server 1100 may further include a wired or wireless network interface, a keyboard, an input-output interface, and other components to facilitate input and output. The server 1100 may further include other components for implementing functions of the device, which are not described again here.

In some exemplary embodiments, a computer-readable storage medium is further provided. The computer-readable storage medium stores at least one program code. The at least one program code, when loaded and executed by a processor, causes a computer to perform any one of the methods for virtual object interaction described above.

In some embodiments, the above computer-readable storage medium is a read-only memory (ROM), a random-access memory (RAM), a compact disc read-only memory (CD-ROM), a magnetic tape, a floppy disk, an optical data storage device, or the like.

In some exemplary embodiments, a computer program or a computer program product is further provided. The computer program or the computer program product stores at least one computer instruction. The at least one computer instruction, when loaded and executed by a processor, causes a computer to perform any one of the methods for virtual object interaction described above.

It should be noted that the information (including but not limited to user device information, user personal information, and the like), data (including but not limited to data for analysis, stored data, displayed data, and the like), and signals, which are referred to in the present disclosure, are authorized by the user or fully authorized by various parties, and the collection, use, and processing of the relevant data are required to comply with relevant laws and regulations and standards in relevant countries and regions.

It should be understood that the term “a plurality of” herein means two or more. The term “and/or” describes the association relationship between the associated objects and indicates that three relationships may be present. For example, A and/or B may indicate (A), (B), or (A and B). The symbol “/” generally indicates an “or” relationship between the associated objects.

Described above are merely exemplary embodiments of the present disclosure and are not intended to limit the present disclosure. Any modifications, equivalent substitutions, improvements, and the like, made within the principle of the present disclosure should fall within the protection scope of the present disclosure.

1. A method for virtual object interaction, comprising:
displaying a first virtual object and a virtual resource within a virtual scene;
displaying, in a case where a first condition is fulfilled, movement of the virtual resource from a position where the virtual resource is located to a resource collection prop corresponding to the first virtual object, wherein the first condition is that a distance between the first virtual object and the virtual resource is less than a distance threshold; and
displaying, in a case where a second condition is fulfilled, upgrade of resource-consuming equipment with virtual resources that have been collected by the resource collection prop corresponding to the first virtual object, to adjust an environmental parameter for the first virtual object to survive within a target area affected by the resource-consuming equipment, wherein the environmental parameter for the first virtual object to survive within the target area affected by the resource-consuming equipment upon the upgrade of the resource-consuming equipment is favorable than an environmental parameter for the first virtual object to survive within the target area affected by the resource-consuming equipment prior to the upgrade of the resource-consuming equipment; or
displaying, in a case where the second condition is fulfilled and the virtual scene changes from a first scene environment to a second scene environment, upgrade of the resource-consuming equipment with the virtual resources that have been collected by the resource collection prop corresponding to the first virtual object, to maintain the environmental parameter for the first virtual object to survive within the target area affected by the resource-consuming equipment, wherein the environmental parameter for the first virtual object to survive within the target area affected by the resource-consuming equipment upon the upgrade of the resource-consuming equipment is the same as the environmental parameter for the first virtual object to survive within the target area affected by the resource-consuming equipment prior to the upgrade of the resource-consuming equipment, wherein the second scene environment is harsher than the first scene environment;
wherein the second condition comprises one of:
a number of the virtual resources that have been collected by the resource collection prop corresponding to the first virtual object being not less than a number threshold, wherein the number threshold indicates a number of virtual resources required by the resource-consuming equipment to upgrade from a current level to a next level;
the number of the virtual resources that have been collected by the resource collection prop corresponding to the first virtual object being not less than the number threshold, and the first virtual object being within a reference area, wherein the reference area is determined based on a position where the resource-consuming equipment is located;
the number of the virtual resources that have been collected by the resource collection prop corresponding to the first virtual object being not less than the number threshold, and a scene environment of the virtual scene changing; or
the number of the virtual resources that have been collected by the resource collection prop corresponding to the first virtual object being not less than the number threshold, and a second virtual object attacking the first virtual object, wherein the second virtual object is a hostile virtual object to the first virtual object.

2. The method according to claim 1, wherein a level of the upgraded resource-consuming equipment is determined based on the number of the virtual resources that have been collected by the resource collection prop corresponding to the first virtual object, and upon the upgrade of the resource-consuming equipment, the environmental parameter for the first virtual object to survive within the target area affected by the resource-consuming equipment is determined based on the level of the upgraded resource-consuming equipment.

3. The method according to claim 1, wherein
the environmental parameter for the first virtual object to survive within the target area affected by the resource-consuming equipment comprises a scene temperature of the virtual scene; the method further comprises:
displaying the scene temperature of the virtual scene; and
subsequent to displaying the upgrade of the resource-consuming equipment with the virtual resources that have been collected by the resource collection prop corresponding to the first virtual object, the method further comprises:
determining a target temperature, wherein the target temperature is the scene temperature of the virtual scene upon the upgrade of the resource-consuming equipment, and the target temperature is determined based on the level of the upgraded resource-consuming equipment; and
updating the displayed scene temperature of the virtual scene to the target temperature.

4. The method according to claim 1, wherein subsequent to displaying the upgrade of the resource-consuming equipment with the virtual resources that have been collected by the resource collection prop corresponding to the first virtual object, the method further comprises:
displaying a first area in a target form, wherein the first area is determined based on a position where the first virtual object is located and the level of the upgraded resource-consuming equipment, and the target form is configured to indicate that the first virtual object is not attacked by a second virtual object in a case where the first virtual object is within the first area, the second virtual object being a hostile virtual object to the first virtual object.

5. The method according to claim 1, wherein subsequent to displaying the movement of the virtual resource from the position where the virtual resource is located to the resource collection prop corresponding to the first virtual object, the method further comprises:
displaying, in a case where a number of the virtual resources that have been collected by the resource collection prop corresponding to the first virtual object is not less than a number threshold, a prompt control, wherein the prompt control indicates that the resource-consuming equipment is upgradable, and the number threshold indicates a number of virtual resources required by the resource-consuming equipment to upgrade from a current level to a next level.

6. The method according to claim 5, wherein subsequent to displaying the prompt control, the method further comprises:
displaying, in response to a trigger operation for the prompt control, an indication element, wherein the indication element indicates a direction of the resource-consuming equipment relative to the first virtual object.

7. The method according to claim 1, wherein subsequent to displaying the upgrade of the resource-consuming equipment with the virtual resources that have been collected by the resource collection prop corresponding to the first virtual object, the method further comprises:
displaying the upgraded resource-consuming equipment, wherein an appearance of the upgraded resource-consuming equipment is different from an appearance of the resource-consuming equipment prior to the upgrade.

8. The method according to claim 1, wherein
the first virtual object performs a scene exploration task in the virtual scene, the virtual scene is covered by a granular covering, the first virtual object holds a first virtual prop, and the first virtual prop is configured to eliminate the granular covering in an application range of the virtual prop; and
upon displaying the upgrade of the resource-consuming equipment with the virtual resources that have been collected by the resource collection prop corresponding to the first virtual, the method further comprises:
adjusting the application range of the first virtual prop, wherein the adjusted application range of the first virtual prop is greater than the application range of the first virtual prop prior to the adjustment.

9. The method according to claim 1, wherein subsequent to displaying the upgrade of the resource-consuming equipment with the virtual resources that have been collected by the resource collection prop corresponding to the first virtual object, the method further comprises:
transferring a second virtual prop to a control object of the first virtual object, wherein the second virtual prop is configured to determine a temperature of a second area as a reference temperature in a case where the first virtual object is equipped with the second virtual prop, wherein the second area is determined based on a position where the first virtual object is located, and the reference temperature is determined based on the second virtual prop.

10. The method according to claim 1, wherein subsequent to the upgrade of the resource-consuming equipment with the virtual resources that have been collected by the resource collection prop corresponding to the first virtual object, the method further comprises:
determining a third area based on the position of the resource-consuming equipment and an adjusted level of the resource-consuming equipment, wherein the third area is greater than a safety area provided by the upgraded resource-consuming equipment; and
displaying movement of a virtual resource present within the third area from a position of the virtual resource to the resource collection prop corresponding to the first virtual object.

11. A computer device, comprising:
a processor and a memory storing at least one program code, wherein the at least one program code, when loaded and executed by the processor, causes the computer device to perform the method for virtual object interaction as defined in claim 1.

12. A non-transitory computer-readable storage medium storing at least one program code, wherein the at least one program code, when loaded and executed by a processor, causes a computer to perform the method for virtual object interaction as defined in claim 1.
